(19) United States
(12) Patent Application Publication
(10) Pub. No.: US 2026/0106229 A1
(43) Pub. Date: Apr. 16, 2026

(54) SOLID-STATE ULTRASONIC BATTERY STRUCTURE CAPABLE OF REMOVING LITHIUM DENDRITES

(71) Applicant: Zhijun Peng, Foshan (CN)

(72) Inventor: Zhijun Peng, Foshan (CN)

(21) Appl. No.: 18/991,749

(22) Filed: Dec. 23, 2024

(30) Foreign Application Priority Data
Oct. 14, 2024 (CN) 202411431575.9

(51) Int. Cl. H01M 10/42; H01M 10/0525

(52) U.S. Cl. CPC H01M 10/4214; H01M 10/0525; H01M 10/4235; H01M 2300/0068

(57) ABSTRACT

A solid-state ultrasonic battery structure capable of removing lithium dendrites, comprising two ultrasonic solid electrolytes, each internally provided with an ultrasonic electrode body, and a separation assembly connected to the two ultrasonic solid electrolytes; wherein the separation assembly drives the two ultrasonic solid electrolytes into close contact or separates them, and when in the separated state, a separation gap is formed between the two ultrasonic solid electrolytes.

### FIELD OF THE INVENTION

The present invention relates to the field of battery technology, and more particularly to a solid-state ultrasonic battery structure capable of removing lithium dendrites.

### BACKGROUND OF THE INVENTION

At present, the main difference between solid-state lithium batteries and liquid-state lithium batteries is that the solid-state lithium battery uses a solid electrolyte instead of a traditional liquid organic electrolyte. This can overcome problems associated with liquid electrolytes, such as leakage, flammability, and narrow operating temperature ranges. However, in a solid-state lithium battery, lithium dendrites still form on the negative electrode during operation. These lithium dendrites may pierce the solid electrolyte, causing short-circuits and affecting the service life of the solid-state battery.

In response, a known solution has emerged, for example, as disclosed in Chinese patent literature with Application No. 201910210719.0, titled “A Solid Electrolyte and Its All-Solid-State Lithium Metal Battery.” The solution mainly includes a positive electrode, a negative electrode, and first and second electrolyte layers disposed between the positive and negative electrodes. By increasing the number of electrolyte layers, the overall thickness of the solid electrolyte is increased, thereby extending the time required for the dendrites to penetrate the electrolyte and achieving the goal of extending battery life. However, in practical applications, this solution still has the following shortcomings:

Because the overall thickness of the solid electrolyte is increased, although it prolongs the time before the lithium dendrites pierce through, it ultimately allows lithium dendrites to continue to grow and accumulate, potentially causing a short-circuit one day. In other words, it does not truly remove the lithium dendrites, leading to low reliability. Moreover, as lithium dendrites accumulate, they hinder the movement of lithium ions, resulting in battery capacity loss and reduced charge-discharge efficiency.

Therefore, the current type of solid-state battery is not the optimal solution.

### SUMMARY OF THE INVENTION

The purpose of the present invention is to solve the above-mentioned problems and shortcomings by providing a solid-state ultrasonic battery structure capable of removing lithium dendrites. This solid-state battery structure uses a separation gap to ensure sufficient space for lithium dendrites to detach and fall off, facilitating their removal. Additionally, by utilizing the ultrasonic cavitation effect, lithium dendrites and chemical impurities do not adhere to the two ultrasonic solid electrolytes, thereby truly achieving the removal of lithium dendrites. This prevents continuous accumulation and growth of lithium dendrites and chemical impurities and avoids the hazards of blockage and piercing caused by lithium dendrites and chemical impurities to the ultrasonic solid electrolytes. As a result, battery safety is greatly enhanced, and battery life is extended.

The technical solution of the present invention is achieved as follows:

A solid-state ultrasonic battery structure capable of removing lithium dendrites is characterized by comprising two ultrasonic solid electrolytes each built-in with an ultrasonic electrode body, and a separation assembly connected to the two ultrasonic solid electrolytes. The separation assembly drives the two ultrasonic solid electrolytes to either tightly contact each other or separate. When they are in the separated state, a separation gap is formed between the two ultrasonic solid electrolytes.

Preferably, the separation assembly includes two micro electric pushrods, with the moving end of each micro electric pushrod fixed to one of the two ultrasonic solid electrolytes.

Preferably, a compression spring is arranged between each micro electric pushrod and the corresponding ultrasonic solid electrolyte.

Preferably, the invention further includes a battery housing with a containing cavity and a battery housing cover. The two ultrasonic solid electrolytes and the separation assembly are respectively installed in the containing cavity. The battery housing cover is placed over the opening of the containing cavity, and two terminals are arranged on the battery housing cover, which are electrically connected to the two ultrasonic electrode bodies.

Preferably, guiding protrusions and guiding grooves that fit in a sliding manner are provided between the two ultrasonic solid electrolytes and the bottom of the containing cavity; guiding protrusions and guiding grooves that fit in a sliding manner are also provided between the two ultrasonic solid electrolytes and the battery housing cover.

Preferably, an air inlet connected to the containing cavity is provided on the battery housing cover, and an air outlet slag-discharge port connected to the containing cavity is provided at the bottom of the battery housing. Both the air inlet and the air outlet slag-discharge port are provided with reusable sealing covers. A funnel-shaped guiding structure is arranged between the bottom of the containing cavity and the air outlet slag-discharge port.

Preferably, a supporting frame is arranged at the bottom of the containing cavity to support the two ultrasonic solid electrolytes, and slag-through holes are provided on the supporting frame.

Preferably, each of the two ultrasonic electrode bodies includes a housing with a working chamber slot, a sliding block arranged in the working chamber slot, and a cover shell mounted on the working chamber slot. The sliding block is provided with a permanent magnet, and the inner side of the cover shell is provided with an electromagnetic coil interacting with the permanent magnet. Both ends of the sliding block are provided with elastic pieces that serve as buffers. Conductive coatings are applied to the surfaces of the housing and the cover shell.

Preferably, a separator is arranged between the two ultrasonic solid electrolytes.

Preferably, the front and rear side edges of the separator are provided with embedded edges. Correspondingly, the walls of the containing cavity are provided with embedded grooves in which the embedded edges are sealingly fitted.

Beneficial effects of the present invention: By setting a separation assembly, the two ultrasonic solid electrolytes can be separated, and the separation gap formed between them ensures sufficient space for lithium dendrites to detach and fall off, making it easy to remove lithium dendrites. Furthermore, using the ultrasonic cavitation effect generated when the ultrasonic electrode body operates ensures that lithium dendrites and chemical impurities do not adhere to the two ultrasonic solid electrolytes. This truly achieves the purpose of removing lithium dendrites, preventing continuous accumulation and growth, and avoiding blockage and piercing hazards caused by lithium dendrites and chemical impurities to the ultrasonic solid electrolytes. Thus, battery safety is greatly improved, and battery life is extended. Meanwhile, through the above structural design, lithium dendrites can be periodically removed to ensure that the movement of lithium ions is not obstructed by dendrites, avoiding capacity loss. Even after long-term use, it still maintains very high battery charge-discharge efficiency and power output. Moreover, in extremely cold weather, it can utilize the ultrasonic cavitation effect to rapidly heat up from inside the battery, accelerating the movement of material molecules inside the battery to achieve a heating effect.

### BRIEF DESCRIPTION OF THE DRAWINGS

FIG. 1 is a schematic diagram of the overall structure of the present invention;

FIG. 2 is an exploded view of the structure of the present invention;

FIG. 3 is a cross-sectional view taken along A-A of FIG. 1 of the present invention, showing the cross-sectional structure when the two ultrasonic solid electrolytes are in a separated state;

FIG. 4 is a cross-sectional view taken along A-A of FIG. 1 of the present invention, showing the cross-sectional structure when the two ultrasonic solid electrolytes are in a tightly contacted state;

FIG. 5 is an exploded view of the ultrasonic electrode body of the present invention;

FIG. 6 is a partially sectional view of the ultrasonic electrode body of the present invention.

### DETAILED DESCRIPTION OF THE EMBODIMENTS

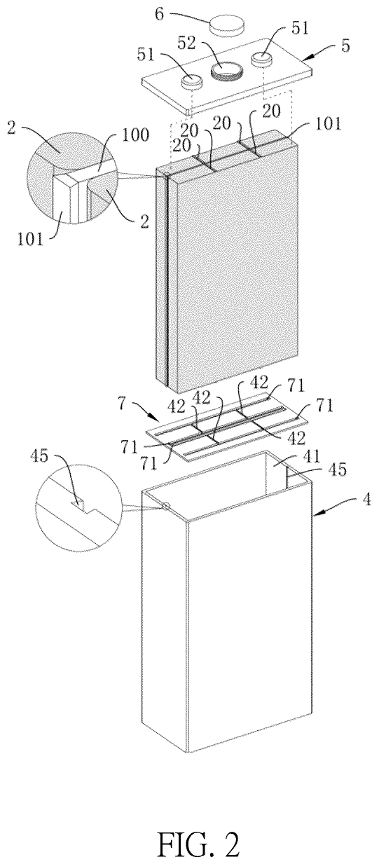

As shown in FIGS. 2 to 4, the solid-state ultrasonic battery structure capable of removing lithium dendrites according to the present invention is a battery cell assembly for assembling a battery product. It includes two ultrasonic solid electrolytes 2, each with an internal ultrasonic electrode body 1, and a separation assembly 3 connected to the two ultrasonic solid electrolytes 2. The separation assembly 3 drives the two ultrasonic solid electrolytes 2 to tightly contact or separate from each other. When in the separated state, a separation gap 30 is formed between the two ultrasonic solid electrolytes 2. Each of the two ultrasonic solid electrolytes 2 can be used as a positive electrode or a negative electrode, adjusted according to practical application.

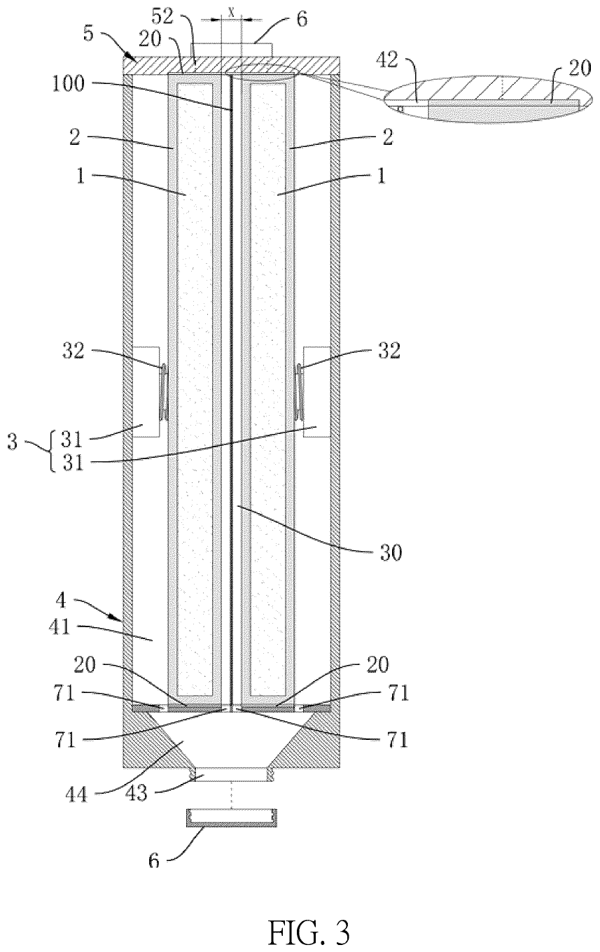

To further improve the structure of the separation assembly 3, as shown in FIG. 3, the separation assembly 3 includes two micro electric pushrods 31, and the moving ends of the two micro electric pushrods 31 are respectively fixed to the two ultrasonic solid electrolytes 2. This allows individual or simultaneous driving of one or both ultrasonic solid electrolytes 2 to achieve separation as needed. In practical applications, the width X of the separation gap 30 is 2-5 mm.

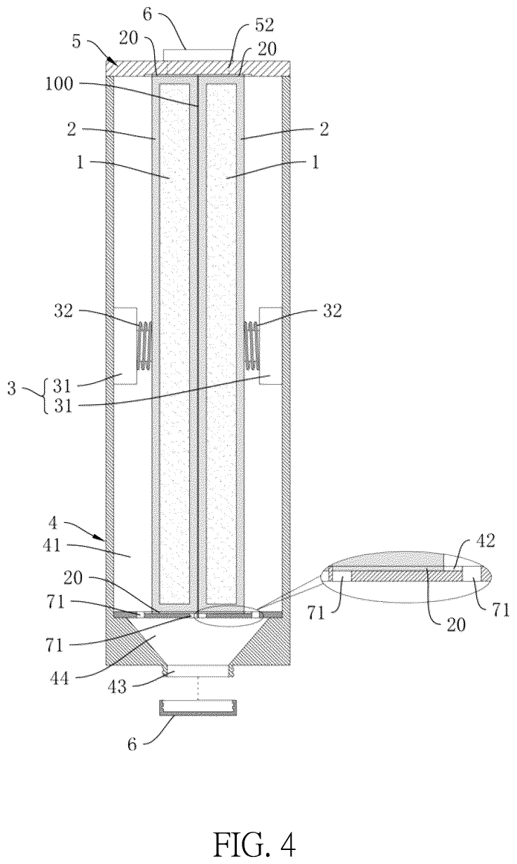

To keep the two ultrasonic solid electrolytes 2 closely attached in the tightly contacted state, as shown in FIG. 4, compression springs 32 are arranged between each micro electric pushrod 31 and the corresponding ultrasonic solid electrolyte 2. In practical applications, the micro electric pushrod 31 may be a commonly available micro electric telescopic pushrod on the market, such as a screw-type electric telescopic pushrod, a hydraulic telescopic pushrod, or a pneumatic pushrod.

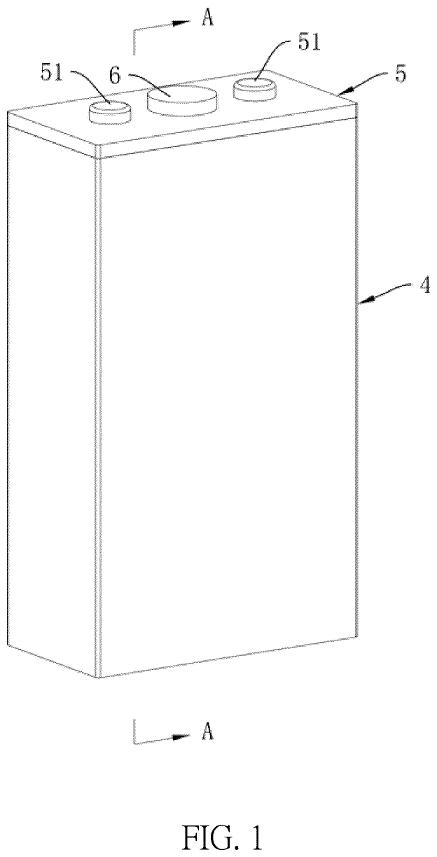

To package the above solutions into a complete battery design, as shown in FIGS. 1 and 2, the invention further includes a battery housing 4 with a containing cavity 41 and a battery housing cover 5. The two ultrasonic solid electrolytes 2 and the separation assembly 3 are respectively installed in the containing cavity 41. The battery housing cover 5 is placed over the opening of the containing cavity 41. Two terminals 51, electrically connected to the two ultrasonic electrode bodies 1, are arranged on the battery housing cover 5. Specifically, the two ultrasonic electrode bodies 1 can be electrically connected to the two terminals 51 via wires.

To ensure that the movement of the two ultrasonic solid electrolytes 2 during separation or close contact is smoother and more reliable without tilting, as shown in FIGS. 3 and 4, guiding protrusions 20 and guiding grooves 42 that fit in a sliding manner are arranged between the two ultrasonic solid electrolytes 2 and the bottom of the containing cavity 41; similarly, guiding protrusions 20 and guiding grooves 42 that fit in a sliding manner are arranged between the two ultrasonic solid electrolytes 2 and the battery housing cover 5. Specifically, each guiding protrusion 20 is arranged at both the upper and lower ends of the two ultrasonic solid electrolytes 2, and each guiding groove 42 is arranged at the bottom of the containing cavity 41 and the battery housing cover 5. Of course, the positions of the guiding protrusions 20 and guiding grooves 42 can be interchanged according to actual manufacturing needs.

To further facilitate the rapid detachment, falling, and discharge of lithium dendrites, as shown in FIG. 3, the battery housing cover 5 is provided with an air inlet 52 connected to the containing cavity 41, and the bottom of the battery housing 4 is provided with an air outlet slag-discharge port 43 connected to the containing cavity 41. Both the air inlet 52 and the air outlet slag-discharge port 43 have reusable sealing covers 6. A funnel-shaped guiding structure 44 is arranged between the bottom of the containing cavity 41 and the air outlet slag-discharge port 43. The sealing covers 6 are connected to the air inlet 52 and the air outlet slag-discharge port 43 via threaded connections. By connecting the air inlet 52 and the air outlet slag-discharge port 43 to a fan or blower, strong airflow can be introduced into the containing cavity 41, thereby promoting the more rapid detachment, falling, and discharge of lithium dendrites. Removing the dendrites in this way can greatly extend the service life of the battery. The funnel-shaped guiding structure 44 helps collect the fallen dendrites and guide them to the air outlet slag-discharge port 43 for discharge.

To keep the two ultrasonic solid electrolytes 2 positioned inside the containing cavity 41 while not affecting the discharge of lithium dendrites, as shown in FIG. 3, a supporting frame 7 is arranged at the bottom of the containing cavity 41 to support the two ultrasonic solid electrolytes 2. The supporting frame 7 is provided with slag-through holes 71. For ease of manufacturing, the guiding grooves 42 at the bottom of the containing cavity 41 can be provided on the supporting frame 7.

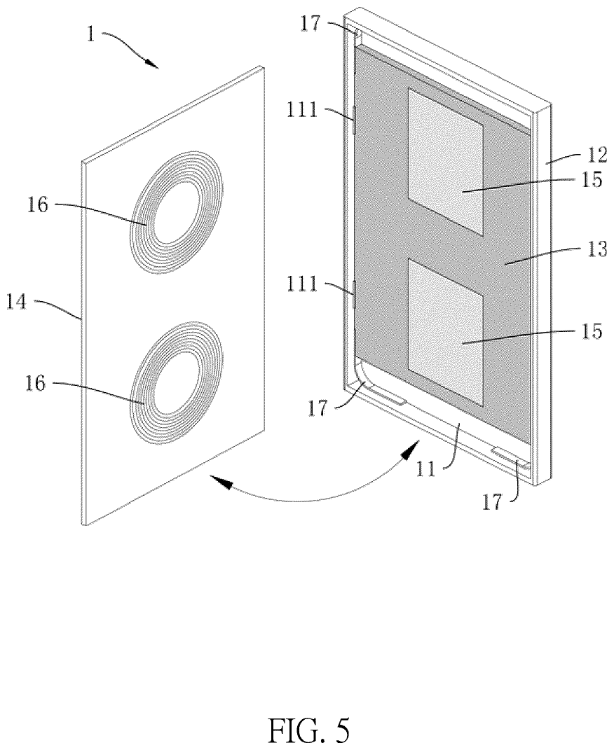

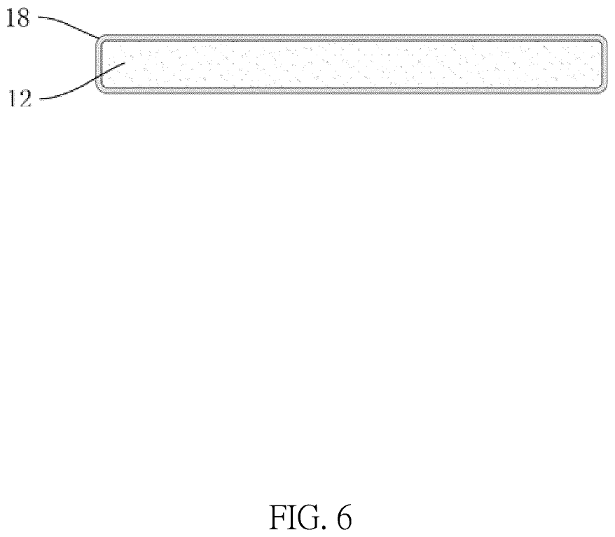

As shown in FIGS. 5 and 6, each ultrasonic electrode body 1 includes a housing 12 with a working chamber slot 11, a sliding block 13 arranged in the working chamber slot 11, and a cover shell 14 mounted over the working chamber slot 11. A permanent magnet 15 is provided on the sliding block 13, and an electromagnetic coil 16 that interacts with the permanent magnet 15 is arranged on the inner side of the cover shell 14. Elastic pieces 17 serving as buffers are arranged at both ends of the sliding block 13. Conductive coatings 18 are applied to the surfaces of the housing 12 and the cover shell 14. By applying the conductive coatings 18, when charging or discharging, the conductive coatings 18 of the ultrasonic electrode body 1 can be energized together with the ultrasonic solid electrolytes 2. The elastic pieces 17 provide a restoring force so that when the electromagnetic coil 16 drives the permanent magnet 15 and the sliding block 13 to move, the sliding block 13 can return to its original position, achieving reciprocating motion. Specifically, a limiting protrusion 111 is arranged in the working chamber slot 11 to prevent the sliding block 13 from leaving the working chamber slot 11. Operating principle: The external circuit supplies current to the electromagnetic coil 16 via a wire. When current passes through the electromagnetic coil 16, it generates a magnetic field, driving the permanent magnet 15 and the sliding block 13 to perform ultra-high-frequency reciprocating motion within the working chamber slot 11, thus generating ultra-high-frequency vibrations. These high-frequency vibrations propagate through solids and other media to form ultrasonic waves. The housing 12 and the cover shell 14 are both made of metal materials.

The power supply wires of the electromagnetic coil 16 pass through the cover shell 14 and are then led out from the side of the two terminals 51 to the outside of the battery housing 4, as shown in FIG. 2.

In addition to the above-mentioned internal ultrasonic components (i.e., composed of the sliding block 13, permanent magnet 15, electromagnetic coil 16, and elastic pieces 17), the present invention can also be implemented by replacing them with ultrasonic vibration motors, ultrasonic transducers, or other similar components.

To facilitate the control of the internal ultrasonic components of the two ultrasonic electrode bodies 1, an external circuit board module is generally arranged outside the battery housing 4. Using the control chip and control switches of the circuit board module, the internal ultrasonic components of the two ultrasonic electrode bodies can be uniformly controlled. Furthermore, the circuit board module can be equipped with a Bluetooth communication module or WiFi communication module, allowing the battery to be connected to the Internet. This enables monitoring and control of the battery using computers, smartphones, and other networked devices.

To further enhance battery safety and prevent short-circuiting, as shown in FIG. 3, a separator 100 is arranged between the two ultrasonic solid electrolytes 2. The separator 100 used in the present invention is the same as a traditional battery separator. A battery separator is a thin film-like sheet placed between the positive and negative electrodes. It is a very crucial component of the battery, having a direct impact on battery safety and cost. Its main function is to isolate the positive and negative electrodes so that electrons cannot pass freely, ensuring that only ions in the ultrasonic solid electrolytes 2 can pass freely between the positive and negative electrodes.

To enable the front and rear ends of the separator 100 to be sealingly assembled to the walls of the containing cavity 41, as shown in FIG. 2, the front and rear side edges of the separator 100 are provided with embedded edges 101. Correspondingly, the walls of the containing cavity 41 are provided with embedded grooves 45 that sealingly fit with the embedded edges 101. By using the embedded grooves 45 and embedded edges 101 to fit together, assembly is made easier, ensuring the separator 100 is securely fixed in position. This prevents short-circuits by separating the two ultrasonic solid electrolytes 2. To better ensure the sealing of the embedded grooves 45 and the embedded edges 101, an adhesive can be applied between them for bonding and curing.

I claim:

1. A solid-state ultrasonic battery structure capable of removing lithium dendrites, comprising:
two ultrasonic solid electrolytes (2), each internally provided with an ultrasonic electrode body (1); and
a separation assembly (3) connected to the two ultrasonic solid electrolytes (2);
wherein the separation assembly (3) can drive the two ultrasonic solid electrolytes (2) into close contact or separated from each other,
and when in the separated state, a separation gap (30) is formed between the two ultrasonic solid electrolytes (2).

2. The solid-state ultrasonic battery structure capable of removing lithium dendrites according to claim 1, wherein the separation assembly (3) comprises two micro electric pushrods (31), and the moving ends of the two micro electric pushrods (31) are respectively fixed to the two ultrasonic solid electrolytes (2).

3. The solid-state ultrasonic battery structure capable of removing lithium dendrites according to claim 2, wherein a compression spring (32) is arranged between each micro electric pushrod (31) and the corresponding ultrasonic solid electrolyte (2).

4. The solid-state ultrasonic battery structure capable of removing lithium dendrites according to claim 1, further comprising a battery housing (4) having a containing cavity (41), and a battery housing cover (5), wherein the two ultrasonic solid electrolytes (2) and the separation assembly (3) are respectively installed in the containing cavity (41), the battery housing cover (5) is placed over the opening of the containing cavity (41), and two terminals (51) electrically connected to the two ultrasonic electrode bodies (1) are arranged on the battery housing cover (5).

5. The solid-state ultrasonic battery structure capable of removing lithium dendrites according to claim 4, wherein guiding protrusions (20) and guiding grooves (42) that fit in a sliding manner are arranged between the two ultrasonic solid electrolytes (2) and the bottom of the containing cavity (41), and guiding protrusions (20) and guiding grooves (42) that fit in a sliding manner are also arranged between the two ultrasonic solid electrolytes (2) and the battery housing cover (5).

6. The solid-state ultrasonic battery structure capable of removing lithium dendrites according to claim 4, wherein an air inlet (52) connected to the containing cavity (41) is arranged on the battery housing cover (5), and an air outlet slag-discharge port (43) connected to the containing cavity (41) is arranged at the bottom of the battery housing (4); both the air inlet (52) and the air outlet slag-discharge port (43) are provided with reusable sealing covers (6); and a funnel-shaped guiding structure (44) is arranged between the bottom of the containing cavity (41) and the air outlet slag-discharge port (43).

7. The solid-state ultrasonic battery structure capable of removing lithium dendrites according to claim 6, wherein a supporting frame (7) is arranged at the bottom of the containing cavity (41) to support the two ultrasonic solid electrolytes (2), and slag-through holes (71) are provided on the supporting frame (7).

8. The solid-state ultrasonic battery structure capable of removing lithium dendrites according to claim 1, wherein each of the two ultrasonic electrode bodies (1) comprises a housing (12) having a working chamber slot (11), a sliding block (13) arranged in the working chamber slot (11), and a cover shell (14) mounted over the working chamber slot (11), wherein a permanent magnet (15) is arranged on the sliding block (13), and an electromagnetic coil (16) interacting with the permanent magnet (15) is arranged on the inner side of the cover shell (14); elastic pieces (17) serving as buffers are arranged at both ends of the sliding block (13); and conductive coatings (18) are applied to the surfaces of the housing (12) and the cover shell (14).

9. The solid-state ultrasonic battery structure capable of removing lithium dendrites according to claim 4, wherein a separator (100) is arranged between the two ultrasonic solid electrolytes (2).

10. The solid-state ultrasonic battery structure capable of removing lithium dendrites according to claim 9, wherein embedded edges (101) are provided at the front and rear side edges of the separator (100), and corresponding embedded grooves (45) for sealing engagement with the embedded edges (101) are arranged on the walls of the containing cavity (41).
